(19) United States
(12) Patent Application Publication
(10) Pub. No.: US 2026/0064059 A1
(43) Pub. Date: Mar. 5, 2026

(54) IMAGE FORMING APPARATUS

(71) Applicant: CANON KABUSHIKI KAISHA, Tokyo (JP)

(72) Inventors: Tadashi Fukumuro, Shizuoka (JP); Kosuke Ogino, Shizuoka (JP); Yuki Sugiyama, Shizuoka (JP); Yuichi Ogawa, Shizuoka (JP)

(21) Appl. No.: 19/311,173

(22) Filed: Aug. 27, 2025

(30) Foreign Application Priority Data
Sep. 3, 2024 (JP) 2024-151484

(51) Int. Cl. G03G 15/23; G03G 15/00

(52) U.S. Cl. CPC G03G 15/234; G03G 15/6564; G03G 2215/00586; G03G 2215/00734

(57) ABSTRACT

An image forming apparatus includes an accommodating unit, a feeding unit, an image forming unit, a transferring unit, a fixing unit, a reverse conveyance unit, a re-conveyance unit, first path, a second path, one drive source, a detection unit, and a control unit. The drive source drives a rotary member in the fixing unit and the reverse conveyance unit. The detection unit detects a recording material passing through the second path. The control unit controls the drive source such that the reverse conveyance unit changes a conveyance speed for conveying a second recording material to be conveyed on the second path following a first recording material in a second direction between a first conveyance speed and a second conveyance speed faster than the first conveyance speed based on a detection result of the detection unit that has detected the first recording material passing through the second path.

### BACKGROUND

### Field of the Technology

The present disclosure relates to an image forming apparatus that forms an image on a recording material.

### Description of the Related Art

Hitherto, a user sometimes performs printing on both sides of a sheet with an image forming apparatus such as a printer or a multifunction peripheral. For this reason, an image forming apparatus having a duplex printing function of automatically reversing and conveying a sheet to form images on both sides of the sheet without requiring the user to manually flip and set the sheet has been developed. Such an image forming apparatus includes a reverse conveyance mechanism for reversing the sheet on a conveyance path in order to implement the duplex printing function. In the reverse conveyance mechanism, the sheet is conveyed to a duplex printing reversing path, the sheet is temporarily stopped on the duplex printing reversing path, and then a reversing roller pair is reversely rotated to convey the sheet in an opposite direction.

As such a reverse conveyance mechanism of the image forming apparatus, a configuration of a re-conveyance system for switching to a re-conveyance path different from the conveyance path on which the sheet is being conveyed and re-conveying the sheet to a transferring unit is known (see JP H06-271144 A). In the image forming apparatus, during duplex printing, the conveyance is resumed after the sheet is temporarily stopped at a temporary stop point for a predetermined time, thereby performing conveyance control to keep a sheet interval constant after performing sheet standby due to a delay at the time of image formation during the duplex printing.

However, there is room for further improvement in the reverse conveyance mechanism of the image forming apparatus described in JP H06-271144 A.

### SUMMARY

The present disclosure provides a new technology related to a reverse conveyance mechanism of an image forming apparatus.

According to a first aspect of the present disclosure, an image forming apparatus includes an accommodating unit configured to accommodate a recording material, a feeding unit configured to feed the recording material accommodated in the accommodating unit, an image forming unit configured to form a toner image, a transferring unit configured to transfer the toner image formed by the image forming unit to the recording material fed by the feeding unit, a fixing unit including a rotary member that heats the toner image transferred to the recording material and configured to fix the toner image to the recording material, a reverse conveyance unit configured to perform reverse conveyance for conveying the recording material to which the toner image is fixed by the fixing unit in a first direction and then conveying the recording material in a second direction opposite to the first direction, a re-conveyance unit configured to again convey the recording material subjected to the reverse conveyance to the transferring unit, a first path forming a path on which the recording material is conveyed from the feeding unit to the transferring unit, a second path forming a path from a point at which the recording material is conveyed in the second direction by the reverse conveyance unit to a point at which the recording material joins the first path, one drive source configured to drive the rotary member and the reverse conveyance unit, a detection unit configured to detect the recording material passing through the second path, and a control unit configured to control the drive source such that the reverse conveyance unit changes a conveyance speed for conveying a second recording material to be conveyed on the second path following a first recording material in the second direction between a first conveyance speed and a second conveyance speed faster than the first conveyance speed based on a detection result of the detection unit that has detected the first recording material passing through the second path.

According to a second aspect of the present disclosure, an image forming apparatus includes an accommodating unit configured to accommodate a recording material, a feeding unit configured to feed the recording material accommodated in the accommodating unit, an image forming unit configured to form a toner image, a transferring unit configured to transfer the toner image formed by the image forming unit to the recording material fed by the feeding unit, a fixing unit including a rotary member that heats the toner image transferred to the recording material and configured to fix the toner image to the recording material, a reverse conveyance unit configured to perform reverse conveyance for conveying the recording material to which the toner image is fixed by the fixing unit in a first direction and then conveying the recording material in a second direction opposite to the first direction, a re-conveyance unit configured to again convey the recording material subjected to the reverse conveyance to the transferring unit, a first path forming a path on which the recording material is conveyed from the feeding unit to the transferring unit, a second path forming a path from a point at which the recording material is conveyed in the second direction by the reverse conveyance unit to a point at which the recording material joins the first path, one drive source configured to drive the rotary member and the reverse conveyance unit, a detection unit configured to detect the recording material passing through the second path, and a control unit configured to control the drive source such that the reverse conveyance unit changes a number of times of reversal in which a conveyance direction of a second recording material conveyed following a first recording material is switched by the reverse conveyance unit between the first direction and the second direction between a first number and a second number smaller than the first number based on a detection result of the detection unit that has detected the first recording material passing through the second path.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to a first embodiment.

FIG. 2 is a control block diagram according to the first embodiment.

FIG. 3 is a flowchart illustrating a first part of a control procedure of a comparative example in the first embodiment.

FIG. 4 is a flowchart illustrating a second part of the control procedure of the comparative example in the first embodiment.

FIG. 5 is a flowchart illustrating a third part of the control procedure of the comparative example in the first embodiment.

FIG. 6 is a flowchart illustrating acceleration/deceleration/temporary stop control of the comparative example in the first embodiment.

FIG. 7A is a flowchart illustrating a fourth part of the control procedure of the comparative example in the first embodiment.

FIG. 7B is a flowchart illustrating reverse acceleration/deceleration control of the comparative example in the first embodiment.

FIG. 8 is a flowchart illustrating a first part of a control procedure in the first embodiment.

FIG. 9 is a flowchart illustrating a second part of the control procedure in the first embodiment.

FIG. 10 is a flowchart illustrating a third part of the control procedure in the first embodiment.

FIG. 11 is a flowchart illustrating a fourth part of the control procedure in the first embodiment.

FIG. 12 is a flowchart illustrating reverse acceleration/deceleration control in the first embodiment.

FIG. 13 is a flowchart illustrating a correction amount setting procedure in the first embodiment.

FIG. 14 is a flowchart illustrating a first part of a control procedure of a comparative example in a second embodiment.

FIG. 15 is a flowchart illustrating a second part of the control procedure of the comparative example in the second embodiment.

FIG. 16A is a flowchart illustrating a third part of the control procedure of the comparative example in the second embodiment.

FIG. 16B is a flowchart illustrating a fourth part of the control procedure of the comparative example in the second embodiment.

FIG. 17 is a flowchart illustrating reverse reciprocation control of the comparative example in the second embodiment.

FIG. 18 is a flowchart illustrating a first part of a control procedure in the second embodiment.

FIG. 19 is a flowchart illustrating a second part of the control procedure in the second embodiment.

FIG. 20 is a flowchart illustrating a third part of the control procedure in the second embodiment.

FIG. 21 is a flowchart illustrating a fourth part of the control procedure in the second embodiment.

FIG. 22 is a flowchart illustrating reverse reciprocation control in the second embodiment.

### DESCRIPTION OF THE EMBODIMENTS

### First Embodiment

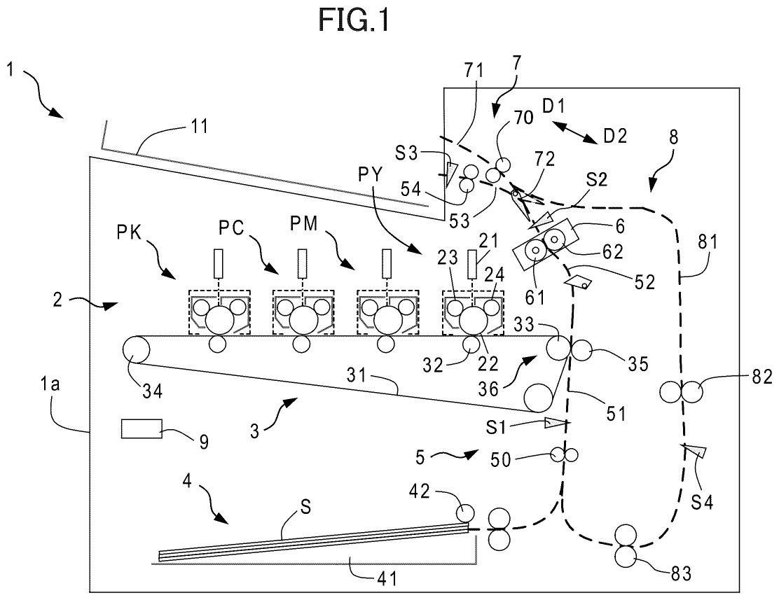

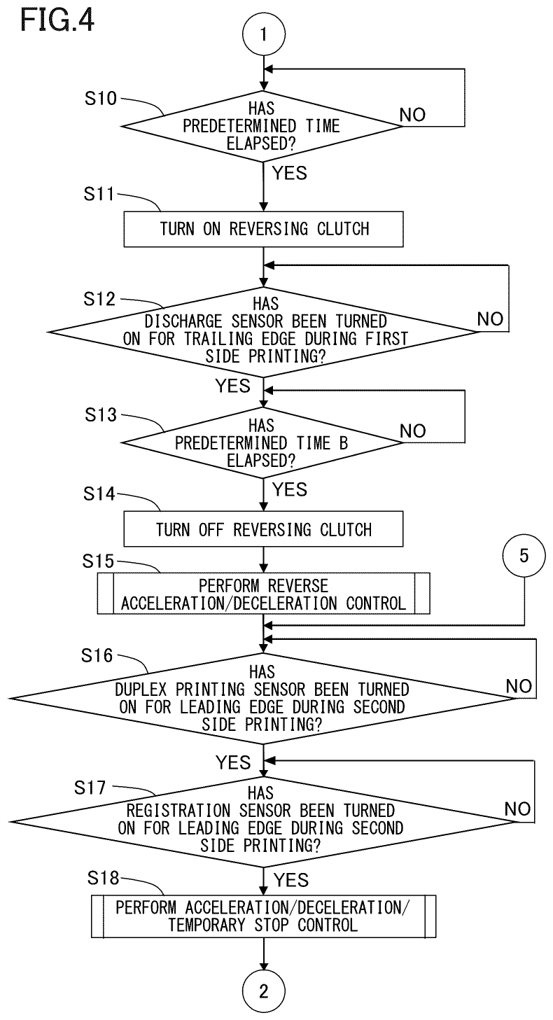

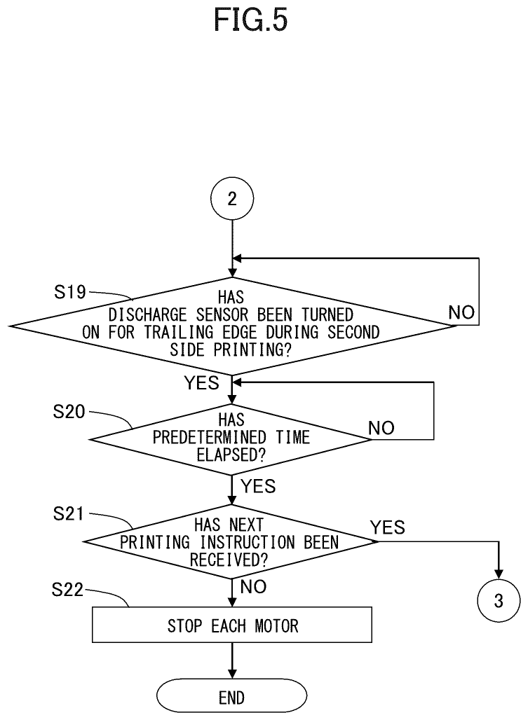

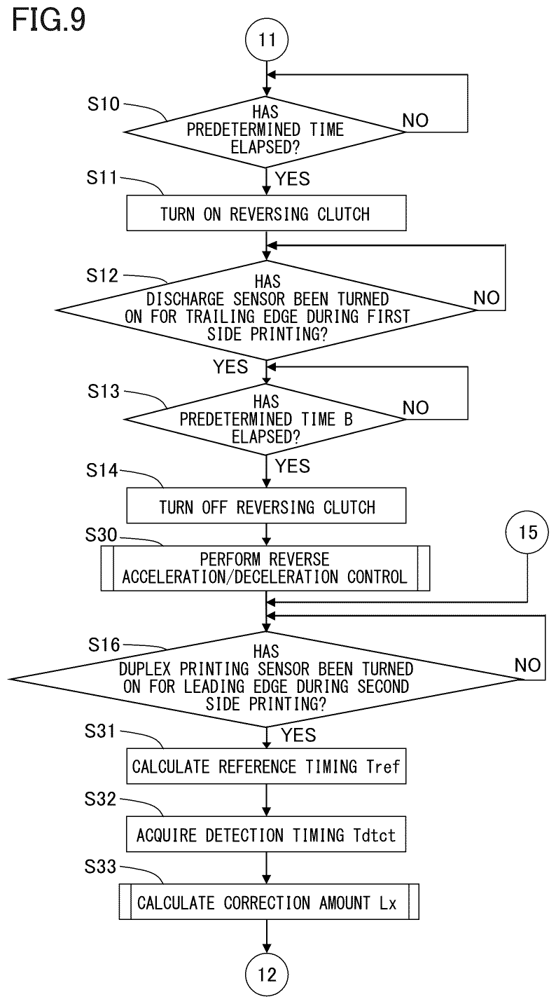

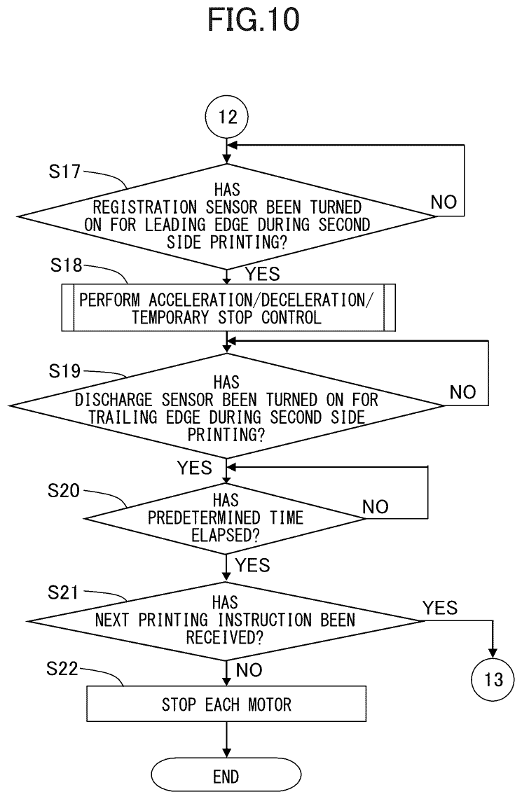

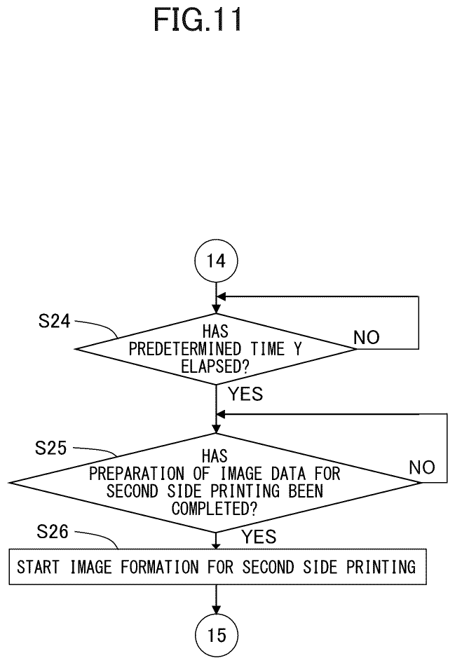

Hereinafter, a first embodiment of the present disclosure will be described in detail with reference to FIGS. 1 to 13. First, a schematic configuration of an image forming apparatus 1 according to the present embodiment will be described with reference to FIG. 1. Dimensions, materials, relative positions, and the like of components of the image forming apparatus 1 are not intended to limit the scope of the present disclosure unless otherwise specified.

### Image Forming Apparatus

FIG. 1 is a schematic view of the image forming apparatus 1 according to the first embodiment. In the present embodiment, the image forming apparatus 1 is an electrophotographic color laser beam printer that forms an image on a sheet S serving as a recording material. The image forming apparatus 1 includes an image forming unit 2, a transfer unit 3, a sheet feeding unit 4, a sheet conveyance unit 5, a fixing unit 6, a reverse conveyance unit 7, a re-conveyance unit 8, a control unit 9, and the like housed in a casing 1a.

The sheet feeding unit 4 includes a sheet cassette 41 on which the sheet S serving as the recording material is supported, and a feed roller 42. The sheet cassette 41 is an example of an accommodating unit that accommodates the sheet S. The feed roller 42 is an example of a feeding unit, and feeds the sheet S accommodated in the sheet cassette 41.

The image forming unit 2 includes process cartridges PY, PM, PC, and PK. In the present embodiment, the image forming unit 2 forms a toner image and transfers the toner image to the transfer unit 3. Each of the process cartridges PY, PM, PC, and PK contains toners (developers) of yellow (Y), magenta (M), cyan (C), and black (K), respectively. Since the process cartridges PY, PM, PC, and PK have the same configuration except that the color of the contained toner is different, the yellow process cartridge PY will be described here. The process cartridge PY includes a photosensitive drum 22 corresponding to the yellow toner, a charging roller 23, and a developing roller 24.

The photosensitive drum 22 is formed by applying an organic light conductive layer to an outer periphery of an aluminum cylinder, and rotates by receiving a driving force of a driving motor (not illustrated), and the driving motor rotates the photosensitive drum 22 in a clockwise direction in FIG. 1 according to an image forming operation. The photosensitive drum 22 is an example of an image bearing member, and bears the toner image corresponding to each toner color. Exposure light for the photosensitive drum 22 is transmitted from a scanner unit 21 and selectively exposes a surface of the photosensitive drum 22 to form an electrostatic latent image. The charging roller 23 is an example of a charging unit and charges the surface of the photosensitive drum 22 as a primary charging unit. The scanner unit 21 is an example of an exposure unit and forms the electrostatic latent image by exposing the surface of the photosensitive drum 22 charged by the charging roller 23. The developing roller 24 is an example of a developing unit and develops the electrostatic latent image with a developer to form the toner image for visualization. The developing roller 24 is detachably attached to the process cartridge. In the present embodiment, the image forming unit 2 is a concept including the photosensitive drum 22, the charging roller 23, the scanner unit 21, and the developing roller 24.

The transfer unit 3 includes an intermediate transfer belt 31, a primary transfer roller 32, a driving roller 33 that drives the intermediate transfer belt 31, a tension roller 34 for applying a tension to the intermediate transfer belt 31, and a secondary transfer roller 35. The intermediate transfer belt 31 is an example of a transfer member, is in contact with the photosensitive drum 22, rotates in a counterclockwise direction in FIG. 1 at the time of forming a color image, rotates according to the rotation of the photosensitive drum 22, and receives the transferred toner image by a primary transfer bias applied to the primary transfer roller 32. Here, in the present embodiment, the image formation performed by the image forming unit 2 means the following operation. That is, the image formation is a series of operations in which the scanner unit 21 starts exposure of the photosensitive drum 22 whose surface is charged by the charging roller 23, the electrostatic latent image is formed on the surface of the photosensitive drum 22, and the developing roller 24 visualizes the electrostatic latent image and primarily transfers the visualized image to the intermediate transfer belt 31. Furthermore, in the present specification, the phrase “from the start of the image formation by the image forming unit 2” or the term “image formation start timing” means a timing when the scanner unit 21 starts surface exposure of the photosensitive drum 22. The phrase “from the start of the image formation by the image forming unit 2” or the term “image formation start timing” is not limited to the timing when the scanner unit 21 starts the surface exposure of the photosensitive drum 22. The phrase “from the start of the image formation by the image forming unit 2” or the term “image formation start timing” is used as a start point for controlling various timings related to subsequent sheet conveyance, and thus only needs to be any predetermined timing during the image forming operation. For example, the phrase “from the start of the image formation by the image forming unit 2” or the term “image formation start timing” may be a timing when the yellow developing roller 24 visualizes the electrostatic latent image and primarily transfers the visualized image to the intermediate transfer belt 31.

The intermediate transfer belt 31 nips and conveys the sheet S at a position of the secondary transfer roller 35 to transfer the color toner images on the sheet S in a superimposed manner. That is, the secondary transfer roller 35 sandwiches the intermediate transfer belt 31 and the sheet S with the driving roller 33 to form a secondary transferring unit 36. The secondary transferring unit 36 is an example of a transferring unit and transfers the toner image formed by the image forming unit 2 to the sheet S fed by the feed roller 42.

The fixing unit 6 fixes the transferred toner image while conveying the sheet S, and includes a fixing roller 61 that heats the sheet S and a pressure roller 62 that brings the sheet S into pressure contact with the fixing roller 61. The fixing roller 61 and the pressure roller 62 are formed in a hollow shape, and a heater is built in the fixing roller 61. The fixing roller 61 is an example of a rotary member and heats the toner image transferred to the sheet S while rotating. The sheet S holding the toner image is conveyed by the fixing roller 61 and the pressure roller 62, and the toner image is fixed on a surface of the sheet S by application of heat and pressure. The sheet S after fixing is conveyed to a discharge path 53 and discharged to a discharge tray 11 by a discharge roller pair 54, and the image forming operation is terminated.

The sheet conveyance unit 5 has conveyance paths for conveying the sheet S from the feed roller 42 to the discharge tray 11, and has a printing conveyance path 51, a fixing conveyance path 52, and the discharge path 53 that are continuous in order from the feed roller 42. The printing conveyance path 51 is an example of a first path and forms a path on which the sheet S is conveyed from the feed roller 42 to the secondary transferring unit 36. The fixing conveyance path 52 is a conveyance path for conveying the sheet S from the secondary transferring unit 36 to a switching portion 72 described below. The discharge path 53 is a conveyance path for conveying the sheet S from the switching portion 72 to the discharge tray 11. The sheet conveyance unit 5 includes a registration roller pair 50 provided on the printing conveyance path 51 and the discharge roller pair 54 provided on the discharge path 53. The registration roller pair 50 is disposed between the feed roller 42 and the secondary transferring unit 36. The registration roller pair 50 adjusts a position at which the image is formed on the sheet S by conveying the sheet S fed by the feed roller 42 to the secondary transferring unit 36 and adjusting a speed at which the sheet S is conveyed to the secondary transferring unit 36.

The sheet conveyance unit 5 is provided with a registration sensor S1, a post-fixing sensor S2, and a full-load sensor S3. The registration sensor S1 is provided downstream of the registration roller pair 50 on the printing conveyance path 51 and detects a leading edge and a trailing edge of the conveyed sheet S. The post-fixing sensor S2 is provided downstream of the fixing unit 6 on the fixing conveyance path 52 and detects the leading edge and the trailing edge of the conveyed sheet S. The full-load sensor S3 is provided downstream of the discharge path 53 and detects a state in which the discharge tray 11 is fully loaded with the sheets.

The reverse conveyance unit 7 includes a reversing roller pair 70, a reversing path 71, and the switching portion 72. A portion where the fixing conveyance path 52 and the discharge path 53 are coupled is a branch portion, and the reversing path 71 is coupled to the branch portion. The branch portion is provided with the switching portion 72 that switches the conveyance path for the sheet by rotation. That is, the sheet S conveyed from the fixing conveyance path 52 toward the branch portion is conveyed to the discharge path 53 or the reversing path 71 by switching according to a position of the switching portion 72. Specifically, when the switching portion 72 is positioned on the upper side in FIG. 1, the sheet S is conveyed to the discharge path 53, and when the switching portion 72 is positioned on the lower side in FIG. 1, the sheet S is conveyed to the reversing path 71. The reversing roller pair 70 is an example of a reverse conveyance unit provided on the reversing path 71 and performs reverse conveyance for conveying the sheet S on which the toner image is fixed by the fixing unit 6 in a first direction D1 and then conveying the sheet S in a second direction D2 opposite to the first direction D1. Here, the first direction D1 is a direction from the fixing unit 6 toward a reversing roller pair 70.

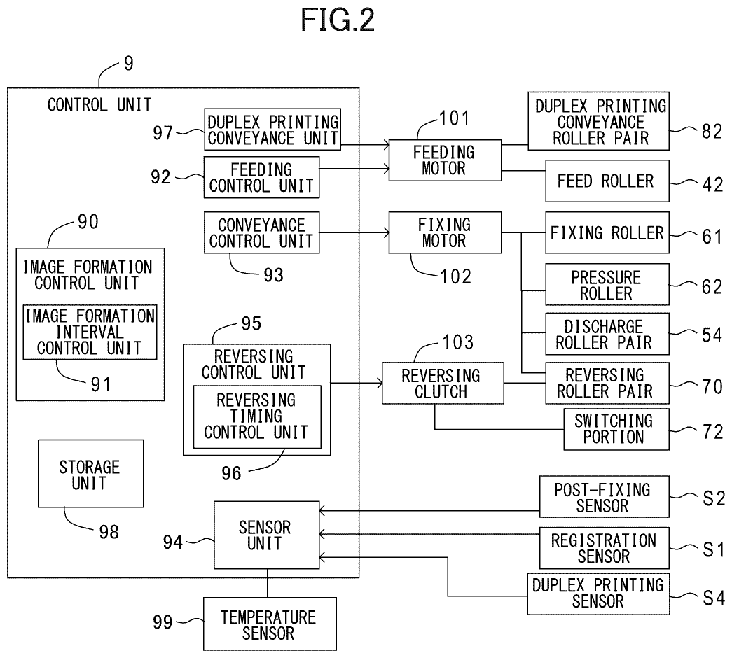

The reverse conveyance unit 7 is provided so as to be attachable to or detachable from the casing 1a, that is, replaceable. The casing 1a is provided with a fixing motor 102 (see FIG. 2) and a reversing clutch 103 (see FIG. 2) that transmits power of the fixing motor 102 to the reversing roller pair 70 and the switching portion 72. The reversing clutch 103 is an example of a reversing unit and is implemented by a disconnection clutch, a plurality of gears, or the like. The reversing clutch 103 is provided on a power transmission path from the fixing motor 102 to the reversing roller pair 70 and the switching portion 72 and switches a direction of a rotational force of the fixing motor 102 to any one of a forward rotation direction or a reverse rotation direction to transmit the rotational force to the reversing roller pair 70 and the switching portion 72.

The re-conveyance unit 8 includes a re-conveyance path 81, a duplex printing conveyance roller pair 82, and a re-feed roller pair 83. The re-conveyance path 81 is coupled to the branch portion. Therefore, the sheet S positioned on the reversing path 71 is conveyed to the re-conveyance path 81 when the switching portion 72 is positioned on the lower side in FIG. 1 and the reversing roller pair 70 reverses the sheet S. A duplex printing sensor S4 capable of detecting the leading edge and the trailing edge of the sheet S passing through the re-conveyance path 81 is disposed in the vicinity of a position downstream of the duplex printing conveyance roller pair 82 on the re-conveyance path 81. A downstream end of the re-conveyance path 81 in a sheet conveyance direction joins at a position between the feed roller 42 and the registration roller pair 50 on the printing conveyance path 51. That is, the re-conveyance path 81 is an example of a second path and forms a path from a point at which the sheet S is conveyed in the second direction D2 by the reversing roller pair 70 to a point at which the sheet S joins the printing conveyance path 51. As a result, the re-conveyance unit 8 again conveys the sheet S reversed and conveyed by the reversing roller pair 70 toward the secondary transferring unit 36.

Next, duplex printing conveyance control when printing is performed on the first side (front surface) and the second side (back surface) of the sheet S will be described. The sheet S subjected to printing on the first side and passing through the fixing unit 6 is conveyed to the reversing path 71 by switching a rotation direction of the reversing roller pair 70 and the switching portion 72 using the reversing clutch 103 described below. When the trailing edge of the sheet S reaches the reversing path 71, the reversing clutch 103 switches the rotation direction of the reversing roller pair 70 and the switching portion 72 again, and the sheet S is conveyed to the re-conveyance path 81. The sheet S whose conveyance direction is reversed from the first direction D1 to the second direction D2 is conveyed on the re-conveyance path 81 by a duplex printing conveyance roller pair 82 and the re-feed roller pair 83. When switching the sheet conveyance direction on the reversing path 71, the fixing motor 102 remains driven, and thus the drive to the reversing roller pair 70 is not interrupted. Therefore, the sheet S is continuously conveyed without being stopped at the reversing roller pair 70 except for a short time required for changing a driving gear train. In this manner, the sheet S enters the printing conveyance path 51 again in a state in which the sheet S is flipped, the toner image is transferred and fixed to the second side, and the sheet S is discharged to the discharge tray 11.

### Control System

FIG. 2 is a control block diagram illustrating a control system and a functional configuration according to the first embodiment. The control unit 9 controls the image forming unit 2 by an image formation control unit 90 to perform image formation. The image formation control unit 90 determines a timing to perform the image formation according to an image interval determined by an image formation interval control unit 91. A feeding control unit 92 issues a rotation instruction to a feeding motor 101 to rotate the feed roller 42, thereby feeding the sheet S. The image formed by the image forming unit 2 is transferred to the fed sheet S. A conveyance control unit 93 issues a rotation instruction to the fixing motor 102 to rotationally drive the fixing roller 61, the pressure roller 62, the discharge roller pair 54, and the reversing roller pair 70, thereby conveying the sheet S to the discharge tray 11. The fixing motor 102 is an example of a drive source, and only one fixing motor is provided.

Next, functions in the duplex printing conveyance control when printing is performed on the first side and the second side of the sheet S will be described. By turning on the reversing clutch 103, the position of the switching portion 72 is switched to convey the sheet S toward the reversing path 71. A sensor unit 94 detects the leading edge of the sheet S by using the registration sensor S1, and the feeding control unit 92 determines whether or not it is necessary to change a speed of the feeding motor 101 and a speed change timing based on a time difference from an image formation timing determined by the image formation interval control unit 91. The sensor unit 94 detects the trailing edge of the sheet S by using the post-fixing sensor S2, a reversing timing control unit 96 determines a reversing timing, and a reversing control unit 95 turns off the reversing clutch 103 to convey the sheet S conveyed toward the reversing path 71 to the re-conveyance path 81.

Thereafter, the sensor unit 94 detects the leading edge of the sheet S conveyed to the re-conveyance path 81 by using the duplex printing sensor S4 which is an example of a detection unit. The reversing roller pair 70 uses the fixing motor 102 as a drive source, and rotates so as to convey the sheet S in the second direction D2 toward the re-conveyance path 81 when the reversing clutch 103 is turned off. On the other hand, the reversing roller pair 70 rotates so as to convey the sheet S in the first direction D1 toward the reversing path 71 when the reversing clutch 103 is turned on. When the reversing clutch 103 is turned off, the switching portion 72 is positioned on the upper side in FIG. 1, causes the fixing conveyance path 52 and the discharge path 53 to communicate with each other, and switches the conveyance path toward the discharge tray 11. When the reversing clutch 103 is turned on, the switching portion 72 is positioned on the lower side in FIG. 1 and causes the fixing conveyance path 52 and the reversing path 71 to communicate with each other. The duplex printing conveyance unit 97 rotates the duplex printing conveyance roller pair 82 by issuing the rotation instruction to the feeding motor 101, thereby conveying the flipped sheet S to the printing conveyance path 51 again.

### Comparative Example 1

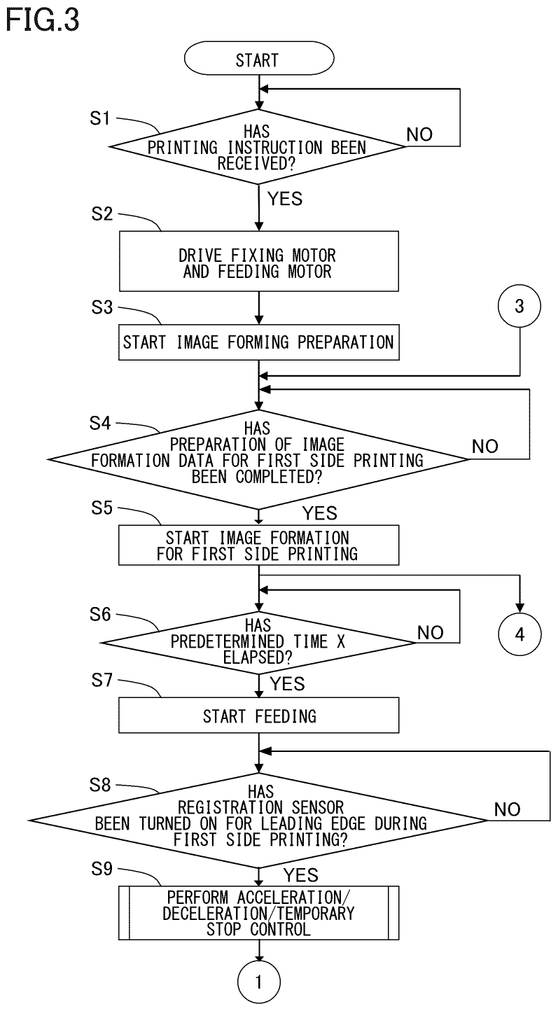

Here, an operation example of the control unit 9 during duplex printing in a comparative example will be described with reference to flowcharts illustrated in FIGS. 3, 4, 5, 6, 7A, and 7B. The control unit 9 determines whether or not a printing instruction has been received (S1), and in a case where it is determined that the printing instruction has been received (S1: YES), the control unit 9 drives the fixing motor 102 and the feeding motor 101 as a preparation operation for sheet conveyance (S2). The control unit 9 starts an image forming preparation operation of the image forming unit 2 (S3). Once image formation preparation is completed, the control unit 9 determines whether or not preparation of image formation data for first side printing in the duplex printing has been completed (S4). In a case where it is determined that the preparation has been completed (S4: YES), the control unit 9 starts formation of the toner image for the first side printing (S5). With a start time of the formation of the toner image as a base point, monitoring of the lapse of a time X until a feeding operation for the first side printing in the duplex printing is started and monitoring of the lapse of a time Y until image formation for second side printing in the duplex printing is started are simultaneously started in parallel (S6 and S24).

Here, the time X in the present embodiment is determined in advance by the following calculation formula. Hereinafter, it is assumed that each ideal time is set in advance and recorded in a storage unit 98 or the like.

Time X=Xi−Xp
Time Xi: The ideal time until the toner image formed by the image forming unit 2 reaches the secondary transfer roller 35
Time Xp: The ideal time until the sheet S fed from the feed roller 42 reaches the secondary transfer roller 35

In the image forming apparatus 1 in the present embodiment, Xi>Xp, and thus, the feeding operation for the corresponding sheet S is started after the image formation is started.

In addition, the time Y in the present embodiment is determined in advance by the following calculation formula.

Time Y=Yp1+Yp2+Yp3
Time Yp1: The ideal time until the leading edge of the sheet during the first side printing reaches the reversing roller pair 70 from the secondary transfer roller 35
Time Yp2: An ideal conveyance time corresponding to a length of the sheet
Time Yp3: The ideal time until the leading edge of the sheet during the second side printing reaches the secondary transfer roller 35 from the reversing roller pair 70

The control unit 9 determines whether or not the time X has elapsed (S6), and in a case where it is determined that the time X has elapsed (S6: YES), the control unit 9 starts the feeding operation for the first side printing in the duplex printing (S7). On the other hand, the control unit 9 determines whether or not the time Y has elapsed (S24), and in a case where it is determined that the time Y has elapsed (S24: YES), the control unit 9 determines whether or not preparation of image formation data for the second side printing in the duplex printing has been completed (S25). In a case where it is determined that the preparation of the image formation data for the second side printing in the duplex printing has been completed (S25: YES), the control unit 9 starts a feeding operation for the second side printing in the duplex printing (S26). The image formation for the second side printing in the duplex printing is started in parallel with a conveyance operation for the first side printing in the duplex printing, which proceeds when the feeding operation is started.

The control unit 9 determines whether or not the leading edge of the sheet during the first side printing in the duplex printing has reached the registration sensor S1 (S8), and in a case where it is determined that the leading edge of the sheet has reached the registration sensor S1 (S8: YES), the control unit 9 performs acceleration/deceleration/temporary stop control at a timing when the leading edge of the sheet has reached the registration sensor S1 (S9).

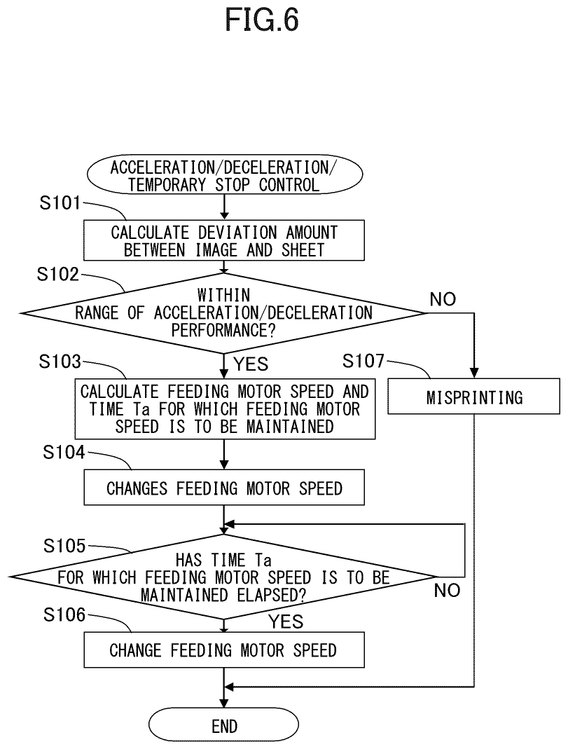

Here, the acceleration/deceleration/temporary stop control in the present embodiment will be described with reference to a flowchart illustrated in FIG. 6. In the acceleration/deceleration/temporary stop control, the control unit 9 controls the feeding motor 101 in order to convey the sheet S by a predetermined distance from the registration roller pair 50 to the secondary transfer roller 35 within the same time as the remaining time until the toner image reaches the secondary transfer roller 35. Here, the feeding motor 101 is controlled to be accelerated, decelerated, or stopped. Further, when the leading edge of the sheet S reaches the secondary transfer roller 35, the control unit 9 restores a rotational speed of the feeding motor 101 such that the sheet S and the toner image are conveyed at the same conveyance speed.

The control unit 9 calculates a deviation amount between an image leading edge position and a sheet leading edge position from a difference between a time when the image formation is started and a time when the leading edge of the sheet reaches the registration sensor S1 (S101). The control unit 9 determines whether or not the deviation amount can be eliminated within a range of acceleration/deceleration performance of the feeding motor 101 (S102). In a case where it is determined that the deviation amount can be eliminated (S102: YES), the control unit 9 calculates a target speed of the feeding motor 101 and a time Ta for which the target speed is to be maintained (S103), and changes the speed of the feeding motor 101 (S104). Furthermore, the control unit 9 determines whether or not the time Ta has elapsed from the change of the speed of the feeding motor 101 (S105). In a case where it is determined that the time Ta has elapsed (S105: YES), the control unit 9 changes the speed of the feeding motor 101 to the same speed as that of the toner image (S106), and ends the acceleration/deceleration/temporary stop control. As described above, in a case where S103 to S106 are executed, timings at which the toner image and the leading edge of the sheet reach the secondary transfer roller 35 can be matched.

On the other hand, in a case where it is determined in S102 that the deviation amount cannot be eliminated (S102: NO), the control unit 9 cannot match the timings at which the toner image and the leading edge of the sheet reach the secondary transfer roller 35. Therefore, the control unit 9 determines that misprinting has occurred (S107), and ends the processing without changing the speed of the feeding motor 101.

When the conveyance of the sheet is continued after the acceleration/deceleration/temporary stop control (S9) ends, the leading edge of the sheet S to which the toner image has been transferred approaches the reverse conveyance unit 7 positioned downstream of the fixing unit 6. The control unit 9 conveys the sheet S during the first side printing in the duplex printing to the reversing roller pair 70 until the leading edge of the sheet reaches the branch portion of the conveyance path by the switching portion 72. That is, the control unit 9 determines whether or not a predetermined time has elapsed (S10), and in a case where it is determined that the predetermined time has elapsed (S10: YES), the control unit 9 operates the reversing clutch 103 to switch the position of the switching portion 72 and the rotation direction of the reversing roller pair 70 to an on state (S11). After the leading edge of the sheet enters the reversing path 71, the control unit 9 determines whether or not the trailing edge of the sheet has been detected (ON) by the post-fixing sensor S2 (S12).

In a case where it is determined that the trailing edge of the sheet has been detected by the post-fixing sensor S2 (S12: YES), the control unit 9 determines whether or not a predetermined time B has elapsed (S13). That is, the control unit 9 operates the reversing clutch 103 after the predetermined time B has elapsed from a timing when the trailing edge of the sheet S has reached the post-fixing sensor S2 in order to reverse the conveyance direction for the first side printing in the duplex printing and start pulling of the sheet S into the re-conveyance path 81. In a case where it is determined that the predetermined time B has elapsed (S13: YES), the control unit 9 switches the position of the switching portion 72 and the rotation direction of the reversing roller pair 70 to an off state (S14). The predetermined time B in S13 in the present embodiment is set in advance so as to reverse the sheet conveyance direction at a timing when a sheet trailing edge position during the first side printing in the duplex printing reaches a position of 15 mm upstream of the reversing roller pair 70. However, it is a matter of course that the predetermined time B is not limited to such a time.

Once the sheet conveyance direction is reversed, the control unit 9 conveys the sheet to the re-conveyance path 81 by using the trailing edge of the sheet during the first side printing in the duplex printing as the leading edge of the sheet during the second side printing in the duplex printing. After reversing the sheet conveyance direction, the control unit 9 performs reverse acceleration/deceleration control up to the duplex printing conveyance roller pair 82 (S15).

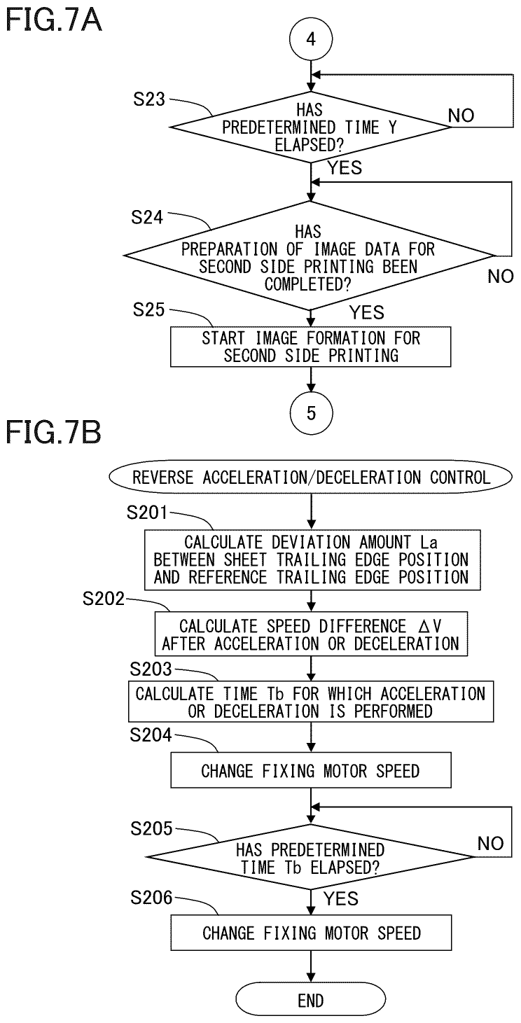

Here, the reverse acceleration/deceleration control in the present embodiment will be described with reference to FIG. 7B. The control unit 9 calculates a deviation from an ideal conveyance timing based on a timing when the trailing edge of the sheet during the first side printing in the duplex printing has reached the post-fixing sensor S2 such that a timing of the leading edge of the sheet during the second side printing in the duplex printing matches the ideal conveyance timing. Then, the control unit 9 performs the reverse acceleration/deceleration control before the sheet S reaches the duplex printing conveyance roller pair 82 after the sheet conveyance direction is reversed.

The control unit 9 acquires a difference between a time Td when the trailing edge of the sheet during the first side printing in the duplex printing has reached the post-fixing sensor S2 and an ideal time Te when the trailing edge of the toner image reaches the duplex printing sensor S4 via the secondary transfer roller 35 from the toner image formation start timing as a start point. The control unit 9 calculates a deviation amount La between the sheet trailing edge position and an ideal trailing edge position based on the difference (S201).
Time Td: A time when the trailing edge of the sheet has reached the post-fixing sensor S2
Ideal time Te: The ideal time when the trailing edge of the toner image reaches the duplex printing sensor S4 via the secondary transfer roller 35 from the image formation start timing

Deviation amount La=(Ideal time Te−Actual arrival time Td)/Conveyance speed

Next, the control unit 9 sets an original speed of the fixing motor 102 as Vref, sets a speed after acceleration or deceleration as Vchg, and obtains a speed difference ΔV (S202).

ΔV=Vref−Vchg

Here, in a case where the deviation amount La is a positive value and the sheet conveyance timing is early, the fixing motor 102 is decelerated, and thus, ΔV becomes a positive value. In a case where the deviation amount La is a negative value and the sheet conveyance timing is delayed, the fixing motor 102 is accelerated, and thus, ΔV becomes a negative value.

In addition, a distance by which the sheet is conveyed during switching from the original speed Vref to the speed Vchg after acceleration or deceleration is defined as Lu, and a distance by which the sheet is conveyed during returning from the speed Vchg after acceleration or deceleration to the original speed Vref is defined as Ld. The control unit 9 calculates a time Tb for which the acceleration or deceleration is performed by dividing a distance obtained by subtracting Lu and Ld from the deviation amount La by the speed difference ΔV (S203).

Tb=(La−(Lu+Ld))=ΔV

The speed Vchg after acceleration or deceleration may be fixed to, for example, +105% or −105% with respect to the original speed, or may be determined according to the deviation amount La, and the speed after acceleration or deceleration is not limited.

The control unit 9 determines the time Tb for which the acceleration/deceleration is performed, reverses the sheet conveyance direction, and then changes a speed of the fixing motor 102 to change a conveyance speed of the reversing roller pair 70 (S204). The control unit 9 determines whether or not the time Tb has elapsed (S205), and in a case where it is determined that the time Tb has elapsed (S205: YES), the speed of the fixing motor 102 is returned to 100% until the leading edge of the sheet during the second side printing in the duplex printing reaches the duplex printing conveyance roller pair 82 (S206). That is, in the reverse acceleration/deceleration control, the control unit 9 calculates the deviation (mm) from the ideal value based on a detection time at the post-fixing sensor S2, and changes the speed of the reversing roller pair 70 so as to eliminate the deviation.

After performing the reverse acceleration/deceleration control (S15), the control unit 9 determines whether or not the leading edge of the sheet during the second side printing in the duplex printing has reached the duplex printing sensor S4 (S16). In a case where it is determined that the leading edge of the sheet during the second side printing in the duplex printing has reached the duplex printing sensor S4 (S16: YES), the control unit 9 then determines whether or not the leading edge of the sheet has reached the registration sensor S1 (S17). In a case where it is determined that the leading edge of the sheet during the second side printing in the duplex printing has reached the registration sensor S1 (S17: YES), the control unit 9 performs the acceleration/deceleration/temporary stop control again (S18). Once the acceleration/deceleration/temporary stop control is completed, the control unit 9 determines whether or not the trailing edge of the sheet during the second side printing in the duplex printing has reached the post-fixing sensor S2 (S19). In a case where it is determined that the trailing edge of the sheet during the second side printing in the duplex printing has reached the post-fixing sensor S2 (S19: YES), the control unit 9 determines whether or not a predetermined time has elapsed (S20). In a case where it is determined that the predetermined time has elapsed (S20: YES), the control unit 9 waits for a sufficient time to discharge the printed sheet S to the discharge tray 11.

The control unit 9 determines whether or not there is a next printing instruction (S21), and in a case where it is determined that there is a next printing instruction (S21: YES), the control unit 9 returns to waiting for completion of preparation of image data for the first side printing (S4). In a case where it is determined that the next printing instruction has not been received (S21: NO), the control unit 9 stops the operations of the feeding motor 101, the fixing motor 102, and the image forming unit 2 (S22), and ends a printing operation.

### Problems of Comparative Example 1

Here, problems occurring in Comparative Example 1 described above will be described. In Comparative Example 1, the rotation direction of the reversing roller pair 70 is switched by operating the reversing clutch 103 in order to reverse the sheet conveyance direction for the first side printing in the duplex printing and start the pulling of the sheet into the re-conveyance path 81. However, due to individual variations and aging of a reverse conveyance mechanism, there is a possibility that a time from output of a reversing command and the operation of the reversing clutch 103 until the rotation direction of the reversing roller pair 70 is switched and the sheet conveyance direction is actually reversed varies. When a variation in conveyance timing on the re-conveyance path 81 increases, a timing when the leading edge during the second side printing in the duplex printing after the conveyance direction is reversed reaches the registration sensor S1 also varies. When such a variation is large, a deviation amount between a toner image timing and the sheet conveyance timing at the secondary transferring unit 36 increases, and a position of the toner image with respect to the sheet is deviated, and thus, a possibility of misprinting increases.

A distance relationship between the roller pair and the sensor of the image forming apparatus 1 in the present embodiment will be considered. In the present embodiment, a conveyance distance from the registration roller pair 50 to the registration sensor S1 is 1 mm, and a conveyance path distance from the reversing roller pair 70 to the registration roller pair 50 is 350 mm. Therefore, in the case of the duplex printing for a legal size sheet, the trailing edge of the sheet during the second side printing is still nipped by the reversing roller pair 70 at a time point when the leading edge of the sheet during the second side printing has reached the registration sensor S1. That is, a path length of the sheet conveyance path from the reversing roller pair 70 to the registration roller pair 50 via the re-conveyance unit 8 is shorter than a maximum length of the legal size sheet S in the sheet conveyance direction, for example, to achieve miniaturization. That is, when the registration roller pair 50 is stopped or decelerated by the acceleration/deceleration/temporary stop control during the second side printing in the duplex printing, a trailing edge side of the sheet during the second side printing is pushed into the re-conveyance path 81 due to a speed difference from the reversing roller pair 70 using the fixing motor 102 as the drive source. As a result, there is a high possibility that problems such as buckling and paper jam of the sheet S being conveyed occur.

On the other hand, it is conceivable to stop or decelerate the reversing roller pair 70 according to the acceleration/deceleration/temporary stop control during the second side printing in order to avoid the buckling and paper jam. However, in this case, it is necessary to stop or decelerate the fixing motor 102, and thus, uniformity of heat in a rotation direction of the fixing roller 61 is lost due to the speed variation of the fixing roller 61, as a result of which fixability of the toner image during the second side printing may be deteriorated.

In the present embodiment, the path length of the sheet conveyance path from the reversing roller pair 70 to the registration roller pair 50 via the re-conveyance unit 8 is shorter than the maximum length of the legal size sheet S in the sheet conveyance direction, for example. However, the present technology is not limited thereto. The path length of the sheet conveyance path from the reversing roller pair 70 to the registration roller pair 50 via the re-conveyance unit 8 may be another length.

### Operation Procedure of Duplex Printing According to Present Embodiment

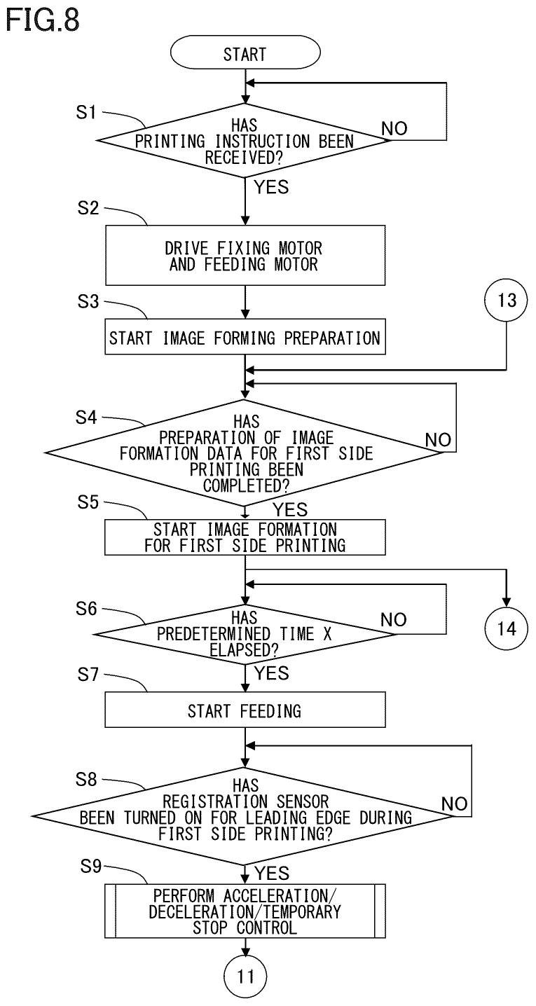

Next, an operation procedure during the duplex printing by the control unit 9 in a case where the present embodiment is applied will be described with reference to flowcharts illustrated in FIGS. 8, 9, 10, 11, 12, and 13. In the flowcharts, S1 to S14 are the same as those in Comparative Example 1, and thus description thereof will be omitted.

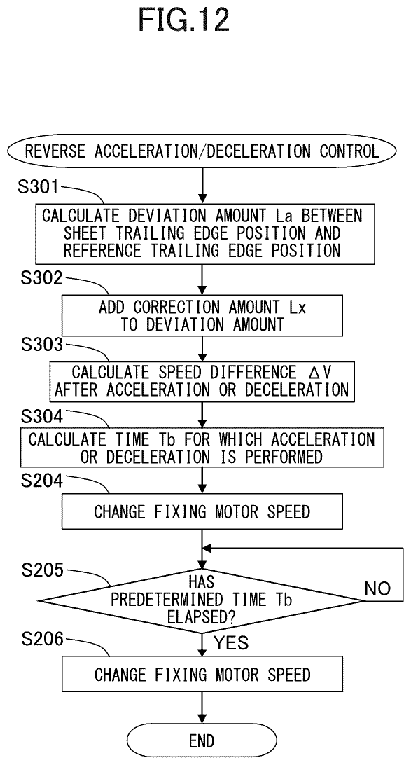

The control unit 9 switches the position of the switching portion 72 and the rotation direction of the reversing roller pair 70 to the off state (S14), and then performs the reverse acceleration/deceleration control (S30). Hereinafter, the reverse acceleration/deceleration control will be described with reference to the flowchart illustrated in FIG. 12. The control unit 9 calculates the deviation amount La between the sheet trailing edge position and the ideal trailing edge position (S301). The calculation of the deviation amount La is similar to that of Comparative Example 1, and thus description thereof will be omitted. In the present embodiment, when a correction amount Lx described below is obtained for a preceding sheet, the reverse acceleration/deceleration control considering the correction amount Lx is performed when performing the reverse acceleration/deceleration control for a subsequent sheet. As a result, the leading edge of the sheet during the second side printing in the duplex printing can reach the duplex printing conveyance roller pair 82 at a timing closer to the ideal conveyance timing than in Comparative Example 1.

In a case where the correction amount Lx is not 0 when performing the reverse acceleration/deceleration control, the control unit 9 adds the correction amount Lx to the deviation amount La between the sheet trailing edge position and the ideal trailing edge position to obtain a corrected deviation amount La0 (S302).

Corrected deviation amount La0=Deviation amount La+Correction amount Lx

Next, the control unit 9 calculates the speed difference ΔV of the fixing motor 102 after the acceleration or deceleration (S303), and calculates the time Tb for which the acceleration or deceleration is performed from the corrected deviation amount La0 (S304).

Tb=(La0−(Lu+Ld))÷ΔV

A method of obtaining ΔV, Lu, and Lb is similar to that of ΔV, Lu, and Lb described in Comparative Example 1, and thus description thereof will be omitted. Further, S204 to S206 are the same as those in Comparative Example 1, and thus description thereof will be omitted.

After performing the reverse acceleration/deceleration control (S30), the control unit 9 determines whether or not the leading edge of the sheet during the second side printing in the duplex printing has reached the duplex printing sensor S4 (S16). In a case where it is determined that the leading edge of the sheet during the second side printing in the duplex printing has reached the duplex printing sensor S4 (S16: YES), the control unit 9 calculates the reference timing Tref (S31). Here, the control unit 9 obtains the reference timing Tref when the leading edge of the sheet during the second side printing in the duplex printing reaches the duplex printing sensor S4 from the image formation start timing for the second side printing by the following calculation formula.

Tref=Xi+Xd
Time Xi: An ideal time until the leading edge of the toner image formed by the image forming unit 2 reaches the secondary transfer roller 35
Time Xd: An ideal time until the leading edge of the sheet S reaches the duplex printing sensor S4 from the secondary transfer roller 35

The control unit 9 acquires an actual timing Tdtct when the leading edge of the sheet reaches the duplex printing sensor S4 from the image formation start timing at a timing when the sheet leading edge during the second side printing in the duplex printing reaches the duplex printing sensor S4 (S32). Furthermore, the control unit 9 compares the reference timing Tref with the actual timing Tdtct, and determines the correction amount Lx for timing correction in the reverse acceleration/deceleration control for the subsequent sheet (S33).

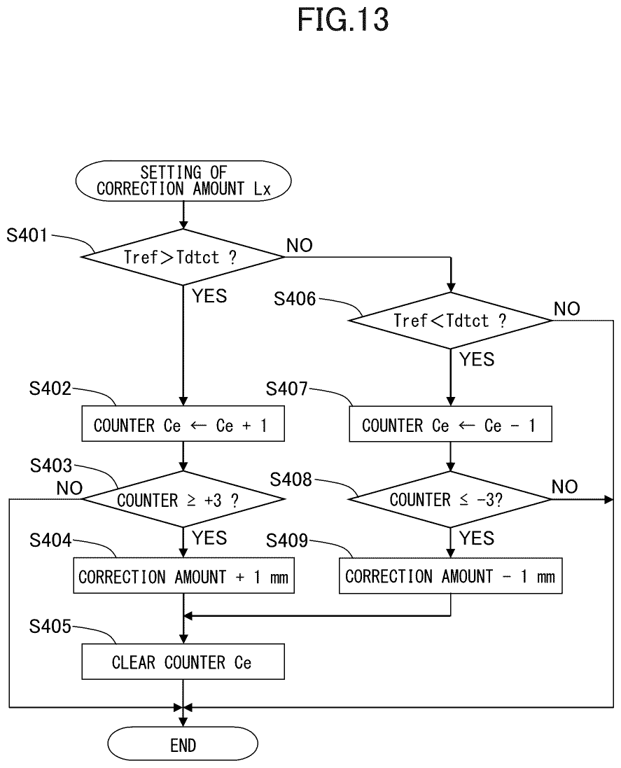

Next, a method of determining the correction amount Lx will be described with reference to the flowchart illustrated in FIG. 13. The control unit 9 determines whether or not Tref>Tdtct (S401), and in a case where it is determined that Tref>Tdtct (S401: YES), the control unit 9 increments an early-arrival counter Ce by 1 (S402). The control unit 9 performs printing of a plurality of sheets, and determines whether or not a value of the early-arrival counter Ce is 3 or more (S403). In a case where it is determined that the value of the early-arrival counter Ce is 3 or more (S403: YES), the control unit 9 increases the correction amount Lx by 1 mm (+1 mm) (S404), and clears the early-arrival counter Ce to 0 (S405).

On the other hand, in a case where it is determined that Tref>Tdtct is not satisfied (S401: NO), the control unit 9 determines whether or not Tref<Tdtct (S406). In a case where the control unit 9 determines that Tref<Tdtct (S406: YES), the control unit 9 decrements the early-arrival counter Ce by 1 (S407). The control unit 9 performs printing of a plurality of sheets and determines whether or not the value of the early-arrival counter Ce is −3 or less (S408). In a case where it is determined that the value of the early-arrival counter Ce is −3 or less, the control unit 9 decreases the correction amount Lx by 1 mm (S409), and clears the early-arrival counter Ce to 0 (S405).

In a case where it is determined in S406 that Tref<Tdtct is not satisfied (S406: NO), Tref=Tdtct. Therefore, the control unit 9 ends the processing without changing the correction amount. Flows S17 to S22 after the correction amount Lx is determined are the same as those of Comparative Example 1, and thus description thereof will be omitted. In the present embodiment, the control unit 9 corrects the deviation amount based on the calculated correction amount (distance) to adjust the sheet conveyance speed. Therefore, the correction amount here has a correlation with the sheet conveyance speed, and calculating the correction amount and correcting the deviation amount have a correlation with adjusting the sheet conveyance speed.

Here, the control unit 9 includes the storage unit 98 such as a random access memory (RAM) or an erasable programmable read-only memory (EPROM) that stores information. The control unit 9 determines whether or not there is a next printing instruction (S21), and in a case where it is determined that there is a next printing instruction (S21: YES), the processing is continued. At this time, the correction amount may be calculated again, or the already calculated correction amount may be stored in the storage unit 98, and a predetermined number of sheets may be printed using the correction amount stored in the storage unit 98 from the next sheet.

Further, the control unit 9 determines whether or not there is a next printing instruction (S21), and in a case where it is determined that the next printing instruction has not been received (S21: NO), the control unit 9 stops the operations of the feeding motor 101, the fixing motor 102, and the image forming unit 2 (S22), and ends the printing operation. At this time, the correction amount set in a print job immediately before the end may be stored in the storage unit 98, and the correction amount may be applied to the first sheet of the next print job. That is, the control unit 9 stores the correction amount in the storage unit 98 in a first image forming job. As described above, the correction amount and the sheet conveyance speed have a correlation, storing the correction amount may mean storing the sheet conveyance speed. Then, the control unit 9 acquires the correction amount from the storage unit 98 in a second image forming job subsequent to the first image forming job, and adjusts the sheet conveyance speed by applying the correction amount to at least the first sheet S conveyed in the second image forming job. As a result, the correction amount can also be applied to the first sheet of the image forming job to optimize a printing position.

In the present embodiment, a temperature sensor 99 (see FIG. 2) is provided in the image forming apparatus 1. The temperature sensor 99 is an example of an environment detection unit that detects environment information, and here, the temperature sensor 99 detects a temperature as the environment information. The control unit 9 can initialize the correction amount stored in the storage unit 98 in a case where a detection result of the temperature sensor 99 exceeds a threshold. Further, the reverse conveyance unit 7 is attachable to and detachable from the casing 1a and is replaceable. The control unit 9 can initialize the correction amount stored in the storage unit 98 in a case where the reverse conveyance unit 7 is replaced.

In the present embodiment, a threshold of the early-arrival counter Ce has been described as 3, but the threshold is not limited thereto and may be another value. In addition, a case where the increase or decrease in correction amount when the early-arrival counter Ce exceeds the threshold is +1 mm has been described, but the value of the increase or decrease is not limited thereto, and other values may be used. In addition, the method of determining the correction amount Lx using the early-arrival counter Ce is merely an example, and there is a method of determining the correction amount Lx based on the difference between the reference timing Tref and the actual timing Tdtct, and a method of determining the correction amount Lx is not limited. For example, in the present embodiment, the deviation amount and the correction amount Lx are obtained as distances, but the present technology is not limited thereto, and the deviation amount and the correction amount Lx may be obtained as time obtained by dividing the correction amount by the speed.

As described above, in the present embodiment, the control unit 9 acquires a detection result of the duplex printing sensor S4 that has detected a preceding sheet (first recording material) conveyed in the second direction D2 by the reversing roller pair 70. The control unit 9 controls the fixing motor 102 so as to change a speed at which the subsequent sheet (second recording material) subsequent to the preceding sheet is conveyed in the second direction D2 by the reversing roller pair 70 based on the detection result. That is, the control unit 9 controls the fixing motor 102 such that the reversing roller pair 70 changes the conveyance speed for conveying the subsequent sheet to be conveyed on the re-conveyance path 81 in the second direction D2 between a first conveyance speed and a second conveyance speed faster than the first conveyance speed based on the detection result of the duplex printing sensor S4 that has detected the preceding sheet passing through the re-conveyance path 81. Here, when a first recording material, a second recording material, and a third recording material are conveyed in order for example, the control unit 9 controls the conveyance speed of the second recording material based on the detection result of the duplex printing sensor S4 that has detected the first recording material passing through the re-conveyance path 81, and controls the conveyance speed of the third recording material based on the detection result of the duplex printing sensor S4 that has detected the second recording material passing through the re-conveyance path 81.

For example, the control unit 9 causes the reversing roller pair 70 to convey the preceding sheet in the second direction D2 at a third conveyance speed, and measures a detection time from the start of the image formation by the image forming unit 2 to the detection of the preceding sheet by the duplex printing sensor S4. Then, in a case where the detection time at this time is a second time shorter than a predetermined first time (ideal time), the control unit 9 controls the first conveyance speed to be slower than the third conveyance speed. On the other hand, in a case where the detection time at this time is a third time longer than the first time, the control unit 9 controls the second conveyance speed to be faster than the third conveyance speed.

Furthermore, in the present embodiment, the conveyance speed is corrected in a case where a plurality of preceding sheets have been reversed with a bias toward an early or delayed timing by using the early-arrival counter. That is, the control unit 9 changes the conveyance speed when the subsequent sheet is conveyed in the second direction D2 based on a plurality of detection results obtained by the duplex printing sensor S4 that has detected a plurality of sheets S conveyed on the re-conveyance path 81 prior to the subsequent sheet.

As described above, in the present embodiment, the control unit 9 changes the speed at which the subsequent sheet is conveyed in the second direction D2 by the reversing roller pair 70 based on the detection result of the duplex printing sensor S4 that has detected the preceding sheet conveyed in the second direction D2 by the reversing roller pair 70. As a result, an image forming position on the sheet S can be determined with high accuracy. In addition, even in a configuration in which the fixing roller 61 and the reversing roller pair 70 are driven by the single fixing motor 102, highly accurate positioning can be performed without stopping the fixing motor 102.

That is, as the reverse acceleration/deceleration control is performed by adding the correction amount Lx to the deviation amount La, the correction amount of the variation in which the rotation direction of the reversing roller pair 70 is switched can also be considered in addition to the deviation amount at the timing at which the sheet has reached the post-fixing sensor S2. Therefore, the leading edge of the sheet during the second side printing in the duplex printing can reach the duplex printing conveyance roller pair 82 at a timing closer to the ideal conveyance timing. As a result, it is possible to align the position of the toner image with respect to the sheet S at the secondary transferring unit 36 with high accuracy by suppressing the variation in the conveyance timing on the duplex printing conveyance path.

In the above-described embodiment, a case where the number of correction amounts Lx is one has been described, but the present technology is not limited thereto. For example, the correction amount Lx may be obtained for each of the conveyance speed of the sheet S at a transfer position of the secondary transfer roller 35, a sheet type (grammage or surface property), a sheet size, and the like. That is, the control unit 9 changes the conveyance speed when the subsequent sheet is conveyed in the second direction D2 based on at least one of the sheet type and the sheet size of the subsequent sheet, and the detection time.

Further, in the above-described embodiment, a case where the correction amount is calculated using a timing when the preceding sheet is detected by the duplex printing sensor S4 has been described, but the present technology is not limited thereto. That is, the detection unit used to calculate the correction amount only needs to detect the sheet passing through the re-conveyance path 81, and is not necessarily disposed on the re-conveyance path 81. For example, a sensor disposed downstream of the reversing roller pair 70 in the sheet conveyance direction and upstream of the secondary transferring unit 36, such as the registration sensor S1 provided at a portion other than the re-conveyance path 81, may be used. However, since the shorter the conveyance distance of the sheet S, the less the disturbance, the use of the duplex printing sensor S4 enables calculation of a more accurate correction amount.

In addition, in the above-described embodiment, a case where the detection time for calculating the correction amount is started from the image formation start timing of the image forming unit 2 has been described, but the present technology is not limited thereto. For example, a timing when the sheet is detected by the registration sensor S1 or a timing when the sheet is detected by the post-fixing sensor S2 may be used.

### Second Embodiment

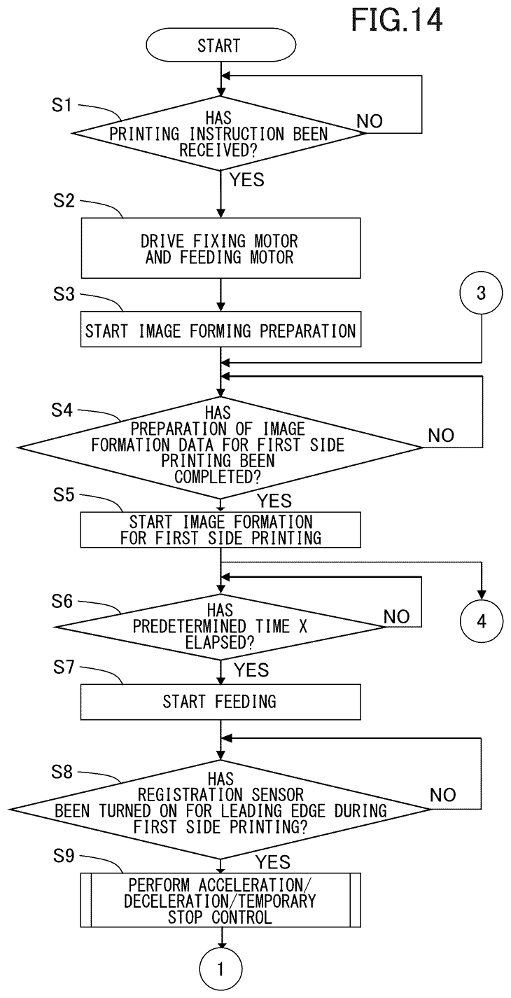

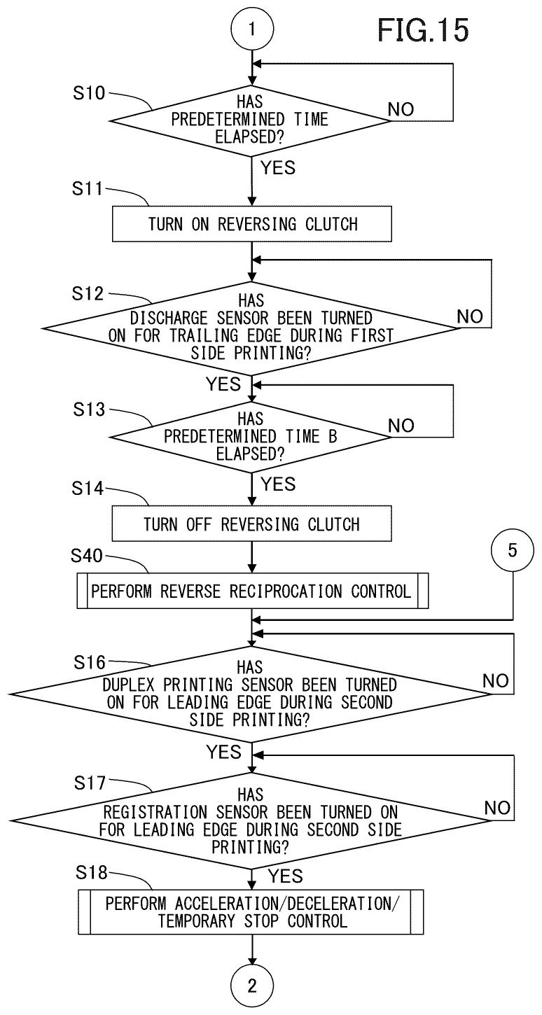

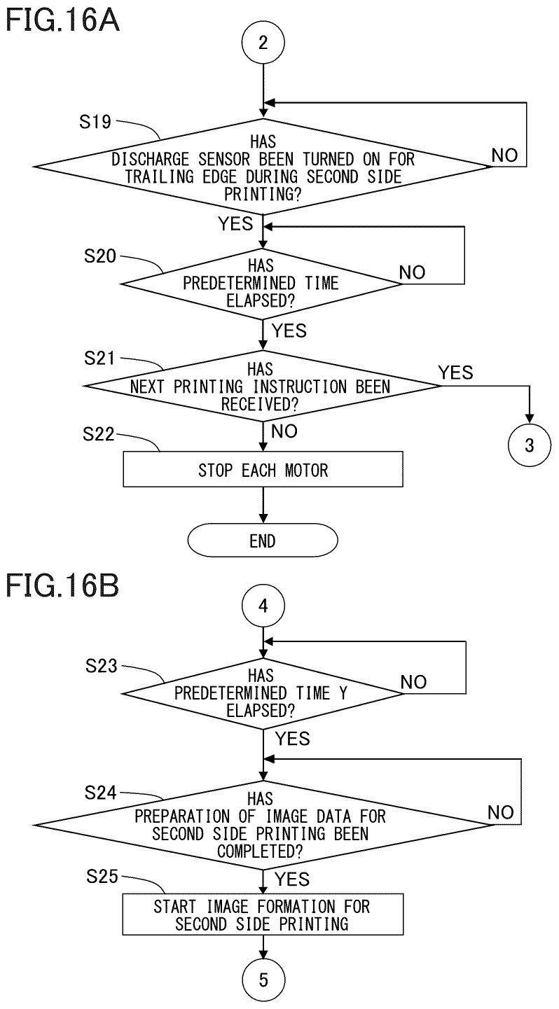

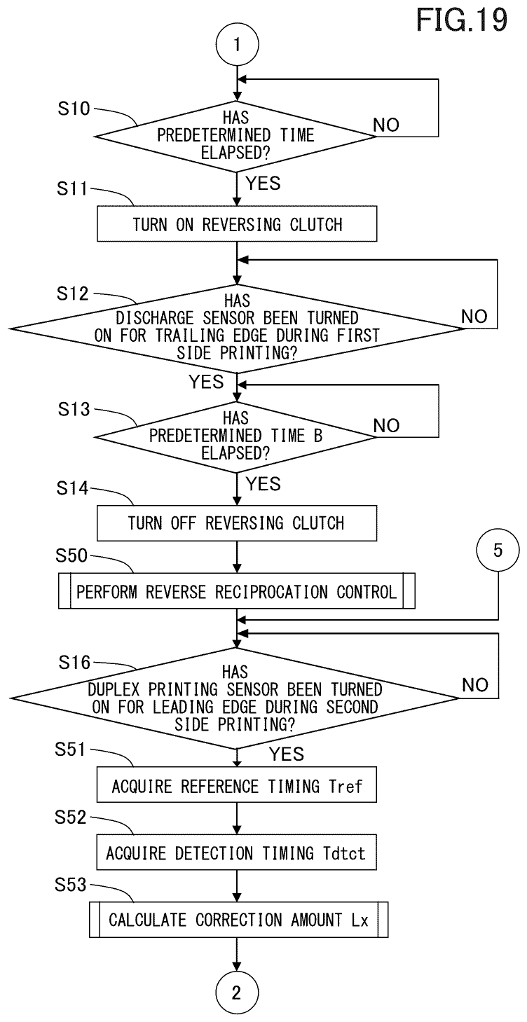

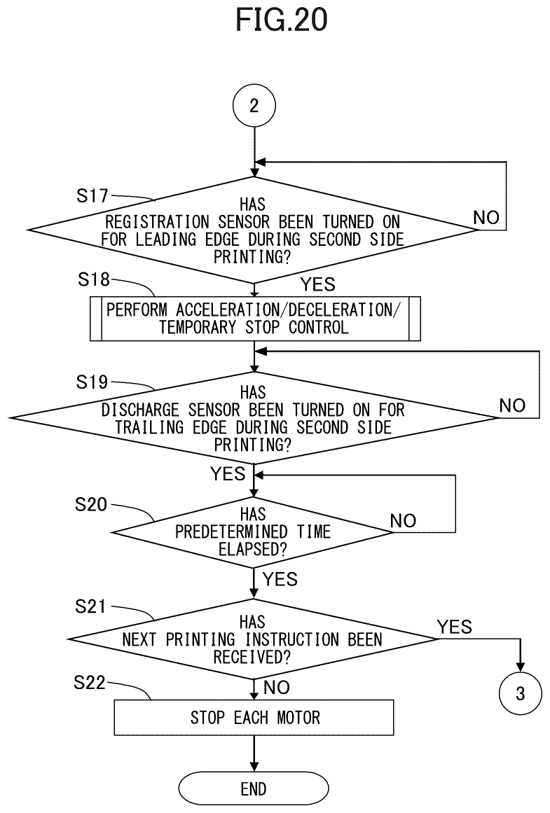

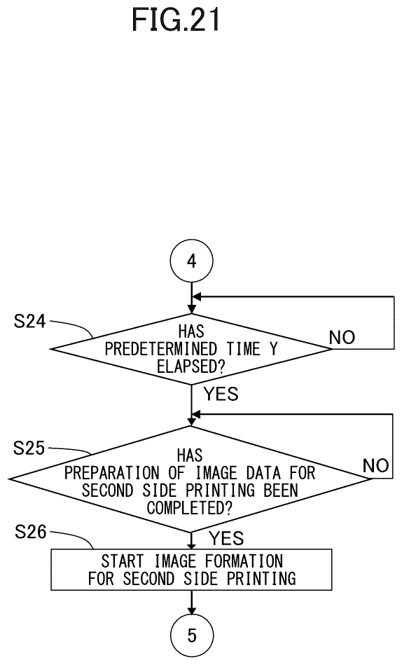

Next, a second embodiment of the present disclosure will be described in detail with reference to FIGS. 14, 15, 16, 17, 18, 19, 20, 21, and 22. The present embodiment is different from the first embodiment in that a reversing roller pair 70 performs reverse reciprocation control instead of the reverse acceleration/deceleration control. However, other configurations are the same as those of the first embodiment, and thus detailed description thereof will be omitted with the same reference numerals applied. In the present embodiment, for a variation in an operation of the reversing roller pair 70, a reversed sheet S reciprocates in a conveyance direction to adjust timings of the reversed and conveyed sheet S and a toner image, so that a positional deviation of the toner image with respect to the sheet S is suppressed.

### Comparative Example 2

First, an operation example of a control unit 9 during duplex printing in Comparative Example 2 for the present embodiment will be described with reference to flowcharts of FIGS. 14 to 17. S1 to S14 are the same as those in the first embodiment, and thus description thereof will be omitted. After a trailing edge of the sheet reaches a post-fixing sensor S2, the control unit 9 switches a position of a switching portion 72 and a rotation direction of the reversing roller pair 70 using a reversing clutch 103 (S14), and performs the reverse reciprocation control (S40).

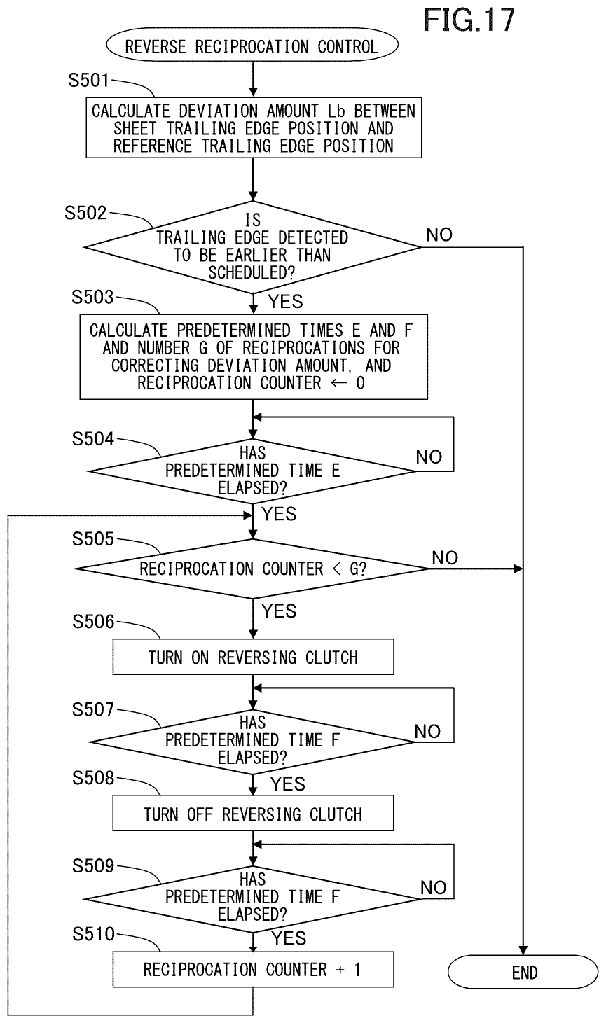

Here, the reverse reciprocation control in the present embodiment will be described with reference to the flowchart illustrated in FIG. 17. The reverse reciprocation control is performed to adjust a deviation amount of a conveyance timing that occurs in a case where a length of the sheet actually conveyed is shorter than a length of the sheet assumed at the start of printing. In the reverse reciprocation control, the control unit 9 calculates a deviation from an ideal conveyance timing based on a timing when the trailing edge of the sheet during first side printing in the duplex printing has reached the post-fixing sensor S2 such that a timing of a leading edge of the sheet during the second side printing in the duplex printing matches the ideal conveyance timing. Then, the control unit 9 operates the reversing clutch 103 during conveyance in a duplex printing conveyance path to reciprocate the reversed sheet in the conveyance direction. In the reverse reciprocation control, it is possible to perform adjustment only to delay the leading edge of the sheet during the second side printing in the duplex printing so as to match the ideal conveyance timing. Therefore, it is acceptable to set a toner image formation start timing corresponding to the sheet during the second side printing in the duplex printing to be delayed in advance according to a variation in an operation of a reverse conveyance mechanism.

The control unit 9 acquires a time Td when the trailing edge of the sheet during first side printing in the duplex printing has reached the post-fixing sensor S2 and an ideal time Te when a trailing edge of the toner image reaches a fixing/discharge sensor via a secondary transfer roller 35 from the toner image formation start timing as a start point. Then, a delay time Th and a deviation amount Lb between a sheet trailing edge position and an ideal trailing edge position are calculated based on a difference between the time Td and the time Te (S501).

The delay time Th and the deviation amount Lb between the sheet trailing edge position and the ideal trailing edge position are obtained by the following calculation formula.

Delay time Th=Ideal time Te−Actual arrival time Td

Here, a minimum value of Th is 0.

Deviation amount Lb=Delay time Th×Conveyance speed

The control unit 9 determines whether or not the time Td when the trailing edge of the sheet has actually reached the post-fixing sensor S2 is detected to be earlier than scheduled based on the ideal time Te (deviation amount Lb>0) (S502). In a case where it is determined that the time Td is detected to be earlier than scheduled (deviation amount Lb>0) (S502: YES), the control unit 9 calculates predetermined times E and F and the number G of reciprocations, and sets a reciprocation counter for counting the reciprocation operation to 0 (S503).

The predetermined time E is obtained by the following calculation formula.

Predetermined time E=(L1−(L2+L3))+Conveyance speed
Distance L1: A distance (135 mm) from the reversing roller pair 70 to a duplex printing conveyance roller pair 82.
Distance L2: A distance (15 mm) from the reversing roller pair 70 to a reversing start position of the leading edge of the sheet during the second side printing in the duplex printing
Distance L3: A margin for prevention of entry into the duplex printing conveyance roller pair 82 (10 mm)

The predetermined time F and the number G of reciprocations are calculated by a calculation formula based on the delay time Th of the conveyance during the second side printing in the duplex printing. In order to prevent falling of the sheet, the number of reciprocations is obtained by the following calculation formula.

The number G of reciprocations=(Th÷2)÷E

Here, G is a positive integer obtained by rounding up decimal places.

Predetermined time F=Th÷(G×2)

The control unit 9 determines whether or not the predetermined time E has elapsed based on a timing when the reversing clutch 103 is turned off (S504). In a case where it is determined that the predetermined time E has elapsed (S504: YES), the control unit 9 determines whether or not a value of the reciprocation counter is less than the number G of reciprocations (S505). In a case where it is determined that the value of the reciprocation counter is less than the number G of reciprocations (S505: YES), the control unit 9 turns on the reversing clutch 103 again (S506). The control unit 9 determines whether or not predetermined time F has elapsed based on a timing when the reversing clutch 103 is turned on again (S507), and in a case where it is determined that the predetermined time F has elapsed (S507: YES), the control unit 9 turns off the reversing clutch 103 again (S508). The control unit 9 determines whether or not the predetermined time F has elapsed based on a timing when the reversing clutch 103 is turned off again (S509), and in a case where it is determined that the predetermined time F has elapsed (S509: YES), the control unit 9 increments the reciprocation counter by 1 (S510) and returns to S505 again.

After performing the reverse reciprocation control (S40), when the value of the reciprocation counter becomes the number G of reciprocations or more, the control unit 9 determines whether or not the leading edge of the sheet during the second side printing in the duplex printing has reached a duplex printing sensor S4 (S16). That is, by executing S506 to S510, the control unit 9 performs the reciprocation operation of reciprocating the sheet by switching the rotation direction of the reversing roller pair 70 twice until the leading edge of the sheet during the second side printing in the duplex printing reaches the duplex printing conveyance roller pair 82 at least once.

In a case where it is determined that a sheet trailing edge detection time is later than scheduled in S502 (S502: NO), the control unit 9 determines whether or not the leading edge of the sheet during the second side printing reaches the duplex printing sensor S4 (S16). Subsequent S16 to S26 are the same as those in the first embodiment, and thus description thereof will be omitted. According to the above control, in a case where the length of the sheet actually conveyed is shorter than the length of the sheet assumed at the start of printing, the reversing clutch 103 can be operated during conveyance in the duplex printing conveyance path to perform the reverse reciprocation control. As a result, a timing when the leading edge of the sheet during the second side printing in the duplex printing reaches a registration roller pair 50 can be delayed.

### Problems of Comparative Example 2

Here, in Comparative Example 2 described above, problems similar to those in Comparative Example 1 may occur. That is, a time from the operation of the reversing clutch 103 to the switching of the rotation direction of the reversing roller pair 70 may vary due to individual variations and aging of the reverse conveyance mechanism. That is, a timing when the leading edge during the second side printing in the duplex printing after the conveyance direction is reversed reaches a registration sensor S1 also varies. When such a variation is large, a deviation amount between a toner image timing and a sheet conveyance timing increases, and thus, a possibility of misprinting increases.

### Operation Procedure of Duplex Printing According to Present Embodiment

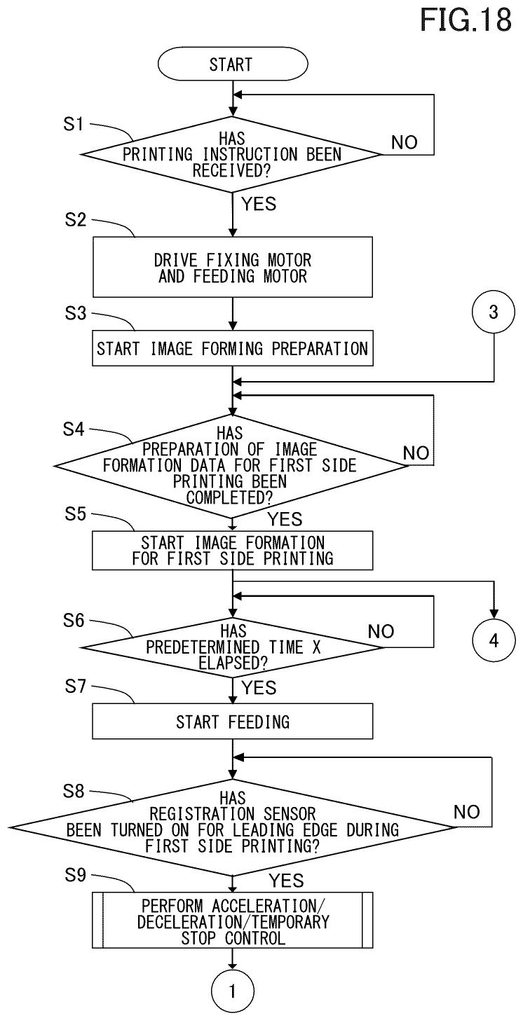

Next, an operation procedure during the duplex printing by the control unit 9 when the present embodiment is applied will be described with reference to flowcharts illustrated in FIGS. 18 to 22. In the flowcharts, S1 to S14 are the same as those of the first embodiment, and thus description thereof will be omitted. After the trailing edge of the sheet reaches the post-fixing sensor S2, the control unit 9 switches the position of the switching portion 72 and the rotation direction of the reversing roller pair 70 using the reversing clutch 103 (S14), and performs the reverse reciprocation control (S50).

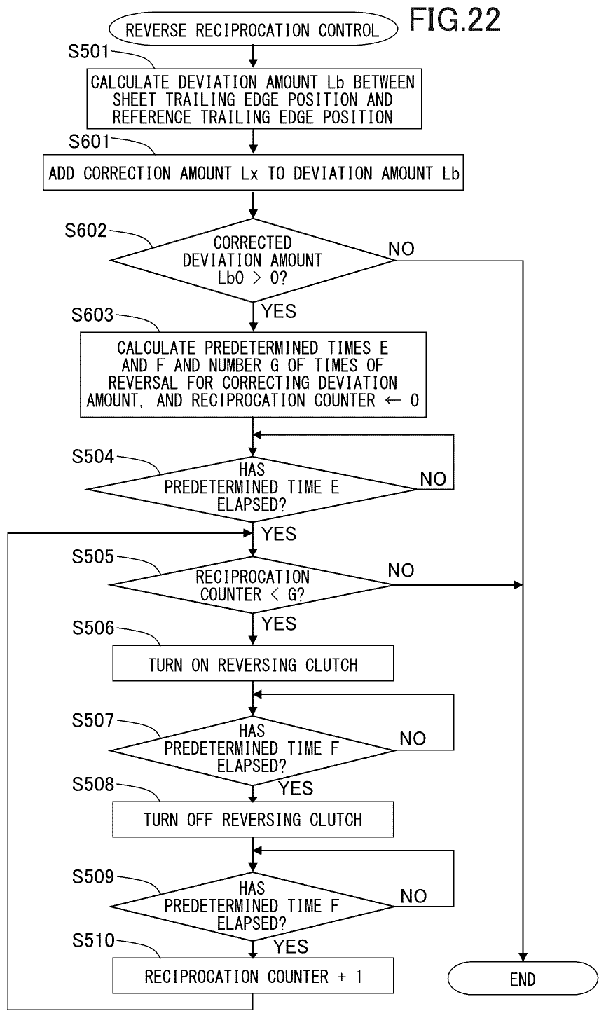

Next, the reverse reciprocation control will be described with reference to the flowchart illustrated in FIG. 22. The control unit 9 acquires the time Td when the trailing edge of the sheet during first side printing in the duplex printing has reached the post-fixing sensor S2 and the ideal time Te when the trailing edge of the toner image reaches the fixing/discharge sensor via the secondary transfer roller 35 from the toner image formation start timing as a start point. The control unit 9 calculates the delay time Th and the deviation amount Lb between the sheet trailing edge position and the ideal trailing edge position from the difference between the time Td and the ideal time Te (S501).

When performing the reverse reciprocation control, the control unit 9 adds a correction amount Lx to the deviation amount Lb between the sheet trailing edge position and the ideal trailing edge position to obtain a corrected deviation amount Lb0 and the delay time Th0 (S601). The corrected deviation amount Lb0 and the delay time Th0 are obtained by the following calculation formula.

Corrected deviation amount Lb0=Deviation amount Lb+Correction amount Lx

Corrected delay time Th0=Corrected deviation amount Lb0÷Conveyance speed

Here, a minimum value of Th0 is 0.

A method of determining the correction amount Lx is similar to that of the first embodiment, and thus description thereof will be omitted. In the present embodiment, the correction amount has a correlation with the number G of reciprocations to be controlled by the control unit 9, and calculating the correction amount and correcting the deviation amount have a correlation with adjusting the number G of reciprocations.

The control unit 9 determines whether or not the corrected deviation amount Lb0 is larger than 0 (S602). In a case where it is determined that the corrected deviation amount Lb0 is larger than 0 and the reverse reciprocation control is necessary (S602: YES), the control unit 9 calculates the predetermined times E and F and the number G of reciprocations (the number of times of reversal), and sets the reciprocation counter for counting the reciprocation operation to 0 (S603). Here, the calculation of the predetermined time E is similar to that in the second comparative example, and thus description thereof will be omitted. The predetermined time F and the number G of reciprocations are calculated by a calculation formula based on the corrected delay time Th0.

The number G of reciprocations=(Th0÷2)÷E

Here, G is a positive integer obtained by rounding up decimal places.

Predetermined time F=Th0÷(G×2)

That is, the control unit 9 controls the fixing motor 102 so as to change the number G of reciprocations in which the subsequent sheet is reversed and conveyed by the reversing roller pair 70 based on the detection result of the duplex printing sensor S4 that has detected a preceding sheet conveyed in a second direction D2 by the reversing roller pair 70. That is, the control unit 9 controls the fixing motor 102 such that the reversing roller pair 70 changes the number G of reciprocations in which the conveyance direction of the subsequent sheet is switched by the reversing roller pair 70 between the first direction D1 and the second direction D2 between a first number and a second number smaller than the first number based on the detection result of the duplex printing sensor S4. In this case, in a case where a detection time from the start of image formation by an image forming unit 2 to the detection of the preceding sheet by the duplex printing sensor S4 is a second time shorter than a predetermined first time, the control unit 9 controls the number G of reciprocations to be a first number. In a case where the detection time is a third time longer than the predetermined first time, the control unit 9 controls the number G of reciprocations to be a second number. In the present embodiment, the control unit 9 changes the number G of reciprocations based on a plurality of detection results obtained by the duplex printing sensor S4 that has detected a plurality of sheets S conveyed on a re-conveyance path 81 prior to the subsequent sheet.

S504 to S510 are the same as those in Comparative Example 2, and thus description thereof will be omitted. In a case where it is determined in S602 that the corrected deviation amount Lb0 is 0 or less and that the reverse reciprocation control is unnecessary (S602: NO), the control unit 9 determines whether or not the leading edge of the sheet during the second side printing has reached the duplex printing sensor S4 (S16). S16 to S26 are the same as those in Comparative Example 2, and thus description thereof will be omitted.

As described above, in the present embodiment, the control unit 9 changes the speed at which the subsequent sheet is conveyed in the second direction D2 by the reversing roller pair 70 based on the detection result of the duplex printing sensor S4 that has detected the preceding sheet conveyed in the second direction D2 by the reversing roller pair 70. As a result, an image forming position on the sheet S can be determined with high accuracy. In addition, even in a configuration in which a fixing roller 61 and the reversing roller pair 70 are driven by the single fixing motor 102, highly accurate positioning can be performed without stopping the fixing motor 102.

According to the present disclosure, it is possible to improve accuracy of a toner image formation position on the sheet at a transferring unit.

### Other Embodiments

In each of the embodiments described above, the reverse acceleration/deceleration control and the reciprocation control are performed, but the present technology is not limited thereto, and both controls may be performed in parallel. For example, in a case where the corrected deviation amount Lb0 is large, the conveyance timing may be adjusted by the reverse reciprocation control, and then the remaining deviation amount that has not been adjusted by the reverse reciprocation control may be finely adjusted by the reverse acceleration/deceleration control.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151484, filed Sep. 3, 2024 which is hereby incorporated by reference herein in its entirety.

What is claimed is:

1. An image forming apparatus comprising:
an accommodating unit configured to accommodate a recording material;
a feeding unit configured to feed the recording material accommodated in the accommodating unit;
an image forming unit configured to form a toner image;
a transferring unit configured to transfer the toner image formed by the image forming unit to the recording material fed by the feeding unit;
a fixing unit including a rotary member that heats the toner image transferred to the recording material and configured to fix the toner image to the recording material;
a reverse conveyance unit configured to perform reverse conveyance for conveying the recording material to which the toner image is fixed by the fixing unit in a first direction and then conveying the recording material in a second direction opposite to the first direction;
a re-conveyance unit configured to again convey the recording material subjected to the reverse conveyance to the transferring unit;
a first path forming a path on which the recording material is conveyed from the feeding unit to the transferring unit;
a second path forming a path from a point at which the recording material is conveyed in the second direction by the reverse conveyance unit to a point at which the recording material joins the first path;
one drive source configured to drive the rotary member and the reverse conveyance unit;
a detection unit configured to detect the recording material passing through the second path; and
a control unit configured to control the drive source such that the reverse conveyance unit changes a conveyance speed for conveying a second recording material to be conveyed on the second path following a first recording material in the second direction between a first conveyance speed and a second conveyance speed faster than the first conveyance speed based on a detection result of the detection unit that has detected the first recording material passing through the second path.

2. The image forming apparatus according to claim 1, wherein
the control unit is configured to
control the drive source to convey the first recording material in the second direction at a third conveyance speed by the reverse conveyance unit,
control the drive source such that the first conveyance speed is slower than the third conveyance speed in a case where a detection time from start of image formation by the image forming unit to detection of the first recording material by the detection unit is a second time shorter than a predetermined first time, and
control the drive source such that the second conveyance speed is faster than the third conveyance speed in a case where the detection time is a third time longer than the first time.

3. The image forming apparatus according to claim 2,
wherein the image forming unit includes:
an image bearing member;
a charging unit configured to charge a surface of the image bearing member;
an exposure unit configured to form an electrostatic latent image by exposing the surface of the image bearing member charged by the charging unit; and
a developing unit configured to develop the electrostatic latent image with a developer to form the toner image, and
wherein the image formation is performed in a manner in which the exposure unit exposes the image bearing member whose surface is charged by the charging unit to form the electrostatic latent image on the surface of the image bearing member, and the developing unit visualizes the electrostatic latent image and transfers the visualized image to a transfer member.

4. The image forming apparatus according to claim 2, wherein the control unit is configured to change the conveyance speed in a case where the second recording material is conveyed in the second direction based on a plurality of the detection results obtained by the detection unit detecting a plurality of recording materials conveyed on the second path prior to the second recording material.

5. The image forming apparatus according to claim 2, wherein the control unit is configured to change the conveyance speed in a case where the second recording material is conveyed in the second direction based on at least one of a sheet type and a sheet size of the second recording material, and the detection time.

6. The image forming apparatus according to claim 2, further comprising a storage unit configured to store information,
wherein the control unit is configured to
store the conveyance speed in a case where the second recording material is conveyed in the second direction in the storage unit in a first image forming job, and
acquire the conveyance speed from the storage unit in a second image forming job subsequent to the first image forming job, and control the drive source such that at least a recording material conveyed first in the second image forming job is conveyed at the conveyance speed by the reverse conveyance unit.

7. The image forming apparatus according to claim 6,
wherein the reverse conveyance unit is replaceable, and
wherein the control unit is configured to initialize the conveyance speed stored in the storage unit in a case where the reverse conveyance unit is replaced.

8. The image forming apparatus according to claim 6, further comprising an environment detection unit configured to detect environment information,
wherein the control unit is configured to initialize the conveyance speed stored in the storage unit in a case where a detection result of the environment detection unit exceeds a threshold.

9. The image forming apparatus according to claim 1, wherein the detection unit is disposed on the second path.

10. The image forming apparatus according to claim 1,
wherein the reverse conveyance unit includes:
a reversing roller pair configured to nip and convey the recording material; and
a reversing unit provided on a power transmission path from the drive source to the reversing roller pair and configured to switch a direction of a rotational force of the drive source to any one of a forward rotation direction or a reverse rotation direction to transmit the rotational force to the reversing roller pair.

11. The image forming apparatus according to claim 1, further comprising a registration roller pair configured to convey the recording material fed by the feeding unit to the transferring unit, and adjust a speed at which the recording material is conveyed to the transferring unit to adjust a position where an image is formed on the recording material,
wherein a path length of a sheet conveyance path from the reverse conveyance unit to the registration roller pair via the re-conveyance unit is shorter than a length of a legal size recording material in a conveyance direction.

12. An image forming apparatus comprising:
an accommodating unit configured to accommodate a recording material;
a feeding unit configured to feed the recording material accommodated in the accommodating unit;
an image forming unit configured to form a toner image;
a transferring unit configured to transfer the toner image formed by the image forming unit to the recording material fed by the feeding unit;
a fixing unit including a rotary member that heats the toner image transferred to the recording material and configured to fix the toner image to the recording material;
a reverse conveyance unit configured to perform reverse conveyance for conveying the recording material to which the toner image is fixed by the fixing unit in a first direction and then conveying the recording material in a second direction opposite to the first direction;
a re-conveyance unit configured to again convey the recording material subjected to the reverse conveyance to the transferring unit;
a first path forming a path on which the recording material is conveyed from the feeding unit to the transferring unit;
a second path forming a path from a point at which the recording material is conveyed in the second direction by the reverse conveyance unit to a point at which the recording material joins the first path;
one drive source configured to drive the rotary member and the reverse conveyance unit;
a detection unit configured to detect the recording material passing through the second path; and
a control unit configured to control the drive source such that the reverse conveyance unit changes a number of times of reversal in which a conveyance direction of a second recording material conveyed following a first recording material is switched by the reverse conveyance unit between the first direction and the second direction between a first number and a second number smaller than the first number based on a detection result of the detection unit that has detected the first recording material passing through the second path.

13. The image forming apparatus according to claim 12,
wherein the control unit is configured to
control the drive source such that the number of times of reversal is the first number in a case where a detection time from start of image formation by the image forming unit to detection of the first recording material by the detection unit is a second time shorter than a predetermined first time, and
control the drive source such that the number of times of reversal is the second number in a case where the detection time is a third time longer than the first time.

14. The image forming apparatus according to claim 13,
wherein the image forming unit includes:
an image bearing member;
a charging unit configured to charge a surface of the image bearing member;
an exposure unit configured to form an electrostatic latent image by exposing the surface of the image bearing member charged by the charging unit; and
a developing unit configured to develop the electrostatic latent image with a developer to form the toner image, and
wherein the image formation is performed in a manner in which the exposure unit exposes the image bearing member whose surface is charged by the charging unit to form the electrostatic latent image on the surface of the image bearing member, and the developing unit visualizes the electrostatic latent image and transfers the visualized image to a transfer member.

15. The image forming apparatus according to claim 13, wherein the control unit is configured to change the number of times of reversal based on a plurality of the detection results obtained by the detection unit detecting a plurality of recording materials conveyed on the second path prior to the second recording material.

16. The image forming apparatus according to claim 13, wherein the control unit is configured to change the number of times of reversal based on at least one of a sheet type and a sheet size of the second recording material, and the detection time.

17. The image forming apparatus according to claim 13, further comprising a storage unit configured to store information,
wherein the control unit is configured to
store the number of times of reversal in the storage unit in a first image forming job, and
acquire the number of times of reversal from the storage unit in a second image forming job subsequent to the first image forming job, and control the drive source such that at least a recording material conveyed first in the second image forming job is subjected to the reverse conveyance by a same number of times as the number of times of reversal by the reverse conveyance unit.

18. The image forming apparatus according to claim 17,
wherein the reverse conveyance unit is replaceable, and
wherein the control unit is configured to initialize the number of times of reversal, stored in the storage unit, by which the reverse conveyance is performed in a case where the reverse conveyance unit is replaced.

19. The image forming apparatus according to claim 17, further comprising an environment detection unit configured to detect environment information,
wherein the control unit is configured to initialize the number of times of reversal, stored in the storage unit, by which the reverse conveyance is performed in a case where a detection result of the environment detection unit exceeds a threshold.

20. The image forming apparatus according to claim 12, wherein the detection unit is disposed on the second path.
